(19) United States
(12) Patent Application Publication
(10) Pub. No.: US 2022/0327624 A1
(43) Pub. Date: Oct. 13, 2022

(54) SYSTEM AND METHOD FOR RATING EQUITY CROWDFUNDING CAPITAL RAISES

(71) Applicant: Kingscrowd, Inc., Berkeley, CA (US)

(72) Inventors: Ahmad Takatkah, Sunnyvale, CA (US); Stephen James Callan, Reading, MA (US); Olivia Marie Strobl, Stafford, VA (US); Francis Nguyen Vu, San Francisco, CA (US)

(21) Appl. No.: 17/709,490

(22) Filed: Mar. 31, 2022

Related U.S. Application Data
(60) Provisional application No. 63/171,598, filed on Apr. 7, 2021.

(51) Int. Cl. G06Q 40/06

(52) U.S. Cl. CPC G06Q 40/06

(57) ABSTRACT

A system and method for rating equity crowdfunding capital raises is disclosed. The method includes receiving a set of equity raise metrics associated with one or more companies from an external database and obtaining a plurality of datapoints of the set of equity raises from the external database. The method further includes calculating a set of z-scores corresponding to each of the plurality of datapoints and generating a set of scores for each of the set of equity raise metrics associated with the one or more companies. Further, the method includes determining an overall raise rating of each of the one or more companies and outputting the generated set of scores and the determined overall raise rating on user interface screen of one or more electronic devices associated with one or more users.

### EARLIEST PRIORITY DATE

This application claims priority from a Provisional patent application filed in the United States of America having Patent Application No. 63/171,598, filed on Apr. 7, 2021, and titled “METHOD AND SYSTEM FOR RATING EQUITY CROWDFUNDING CAPITAL RAISES”.

### FIELD OF INVENTION

Embodiments of the present disclosure relate to quantitative rating systems and more particularly relates to a system and a method for rating equity crowdfunding capital raises.

### BACKGROUND

The JOBS Act of 2012 was enacted to reduce barriers to capital formation, especially for smaller companies. Prior to 2016, only the wealthiest and accredited investors could invest in private start-ups. However, everyone else could not invest in start-ups and the smaller companies to become one of its owners. Currently, there are over thirty platforms engaged in this new opportunity called equity crowdfunding. As the number of private equities' raises rapid growth, it is extremely difficult for individual investors to determine which start-ups and smaller companies they should invest in. Conventionally, there are few quantitative rating systems in the equity crowdfunding market to rate one or more companies to help the individual investors in their investments. However, the conventional systems do not consider multiple parameters, such as price, market, team and the like while rating the one or more companies. Thus, the conventional systems lack accuracy and hence generate inaccurate ratings corresponding to the one or more companies. As a result, the individual investors end up investing in wrong companies and start-ups and incur huge financial losses.

Hence, there is a need for an improved system and method for rating equity crowdfunding capital raises, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for rating equity crowdfunding capital raises is disclosed. The computing system includes one or more hardware processors and a memory coupled to the one or more hardware processors. The memory includes a plurality of modules in the form of programmable instructions executable by the one or more hardware processors. The plurality of modules include a data receiver module configured to receive a set of equity raise metrics associated with one or more companies from an external database. The one or more companies raise a set of equity raises. The set of equity raise metrics include: one or more price parameters, one or more market parameters, one or more team parameters, one or more differentiators parameters and one or more performance parameters. The plurality of modules also include a data obtaining module configured to obtain a plurality of datapoints of the set of equity raises corresponding to the set of equity raise metrics from the external database. The plurality of datapoints include: a set of price data points, a set market data points, a set of team data points, a set of differentiators data points and a set of performance data points. The plurality of modules includes a score calculation module configured to calculate a set of z-scores corresponding to each of the plurality of datapoints associated with each of the one or more companies by applying a standardization technique on each of the obtained plurality of datapoints. Further, the plurality of modules includes a score generation module configured to generate a set of scores for each of the set of equity raise metrics associated with the one or more companies based on the received set of equity raise metrics, the obtained plurality of datapoints and the calculated set of z-scores by using a min-max scaler. The plurality of modules also include a rating determination module configured to determine an overall raise rating of each of the one or more companies by comparing the generated set of scores associated with the one or more companies with each other based on one or more rating parameters and a set of predefined rating rules. The one or more rating parameters include at least one of: company industry, growth stage and all companies raising private equity. Furthermore, the plurality of modules include a data output module configured to output the generated set of scores and the determined overall raise rating on user interface screen of one or more electronic devices associated with one or more users.

In accordance with another embodiment of the present disclosure, a method for rating equity crowdfunding capital raises is disclosed. The method includes receiving a set of equity raise metrics associated with one or more companies from an external database. The one or more companies raise a set of equity raises. The set of equity raise metrics include: one or more price parameters, one or more market parameters, one or more team parameters, one or more differentiators parameters and one or more performance parameters. The method also includes obtaining a plurality of datapoints of the set of equity raises corresponding to the set of equity raise metrics from the external database. The plurality of datapoints include: a set of price data points, a set of market data points, a set of team data points, a set of differentiators data points and a set of performance data points. The method further includes calculating a set of z-scores corresponding to each of the plurality of datapoints associated with each of the one or more companies by applying a standardization technique on each of the obtained plurality of datapoints. Further, the method includes generating a set of scores for each of the set of equity raise metrics associated with the one or more companies based on the received set of equity raise metrics, the obtained plurality of datapoints and the calculated set of z-scores by using a min-max scaler. Also, the method includes determining an overall raise rating of each of the one or more companies by comparing the generated set of scores associated with the one or more companies with each other based on one or more rating parameters and a set of predefined rating rules. The one or more rating parameters include at least one of: company industry, growth stage and all companies raising private equity. Furthermore, the method includes outputting the generated set of scores and the determined overall raise rating on user interface screen of one or more electronic devices associated with one or more users.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for rating equity crowdfunding capital raises, in accordance with an embodiment of the present disclosure;

FIG. 2 is a block diagram illustrating an exemplary computing system for rating equity crowdfunding capital raises, in accordance with an embodiment of the present disclosure;

FIG. 3A is a block diagram illustrating an exemplary set of steps for determining overall raise rating associated with one or more companies, in accordance with an embodiment of the present disclosure;

FIG. 3B is a block diagram illustrating an exemplary set of steps of generating overall rating for each of set of equity raise metrics and overall raise rating associated with the one or more companies, in accordance with an embodiment of the present disclosure;

FIG. 4 is a process flow diagram illustrating an exemplary method for rating equity crowdfunding capital raises, in accordance with an embodiment of the present disclosure;

FIG. 5 is an exemplary graph illustrating a sample data processing, in accordance with an embodiment of the present disclosure;

FIG. 6 is an exemplary graph illustrating a sample overall rating of one or more company's raises showing a positively skewed distribution, in accordance with an embodiment of the present disclosure; and

FIGS. 7A-7G are graphical user interface screens of dashboard of the computing system for rating equity crowdfunding capital raises, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

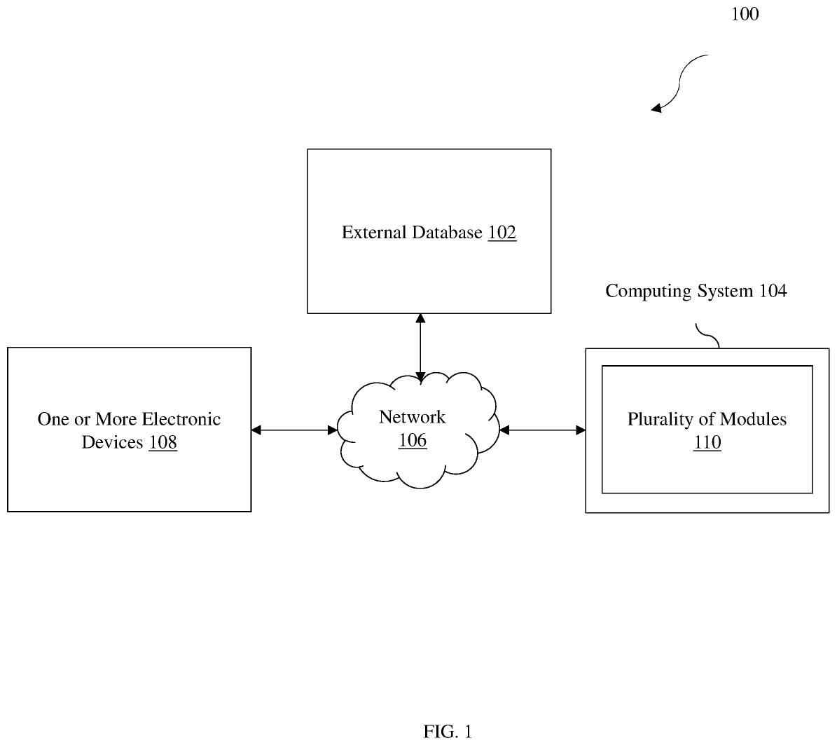

Referring now to the drawings, and more particularly to FIG. 1 through FIG. 7G, where similar reference characters denote corresponding features consistently throughout the figures, there are shown preferred embodiments and these embodiments are described in the context of the following exemplary system and/or method.

FIG. 1 is a block diagram illustrating an exemplary computing environment for rating equity crowdfunding capital raises, in accordance with an embodiment of the present disclosure. According to FIG. 1, the computing environment 100 includes an external database 102 communicatively coupled to a computing system 104 via a network 106. The external database 102 is configured to store a set of equity raise metrics, a plurality of datapoints of the set of equity raises and a set of risk metrics. For example, the external database 102 may be a third-party database associated with a third-party website. The computing system 104 may be hosted on a central server, such as cloud server or a remote server. Further, the network 106 may be internet or any other wireless network.

Further, the computing environment 100 includes one or more electronic devices 108 associated with one or more users communicatively coupled to the computing system 104 via the network 106. In an embodiment of the present disclosure, the one or more users are one or more individual investors who desire to invest in start-ups and one or more companies. The one or more electronic devices 108 are used by the one or more users to receive a set of scores for each of the set of equity raise metrics associated with one or more companies, an overall raise rating of each of the one or more companies, a plurality of scores for each of the set of risk metrics associated with the one or more companies and an overall risk rating of each of the one or more companies. In an embodiment of the present disclosure, the one or more companies correspond to one or more start-ups, one or more smaller companies or a combination thereof. In an exemplary embodiment of the present disclosure, the one or more electronic devices 108 may include a laptop computer, desktop computer, tablet computer, smartphone, wearable device, smart watch and the like.

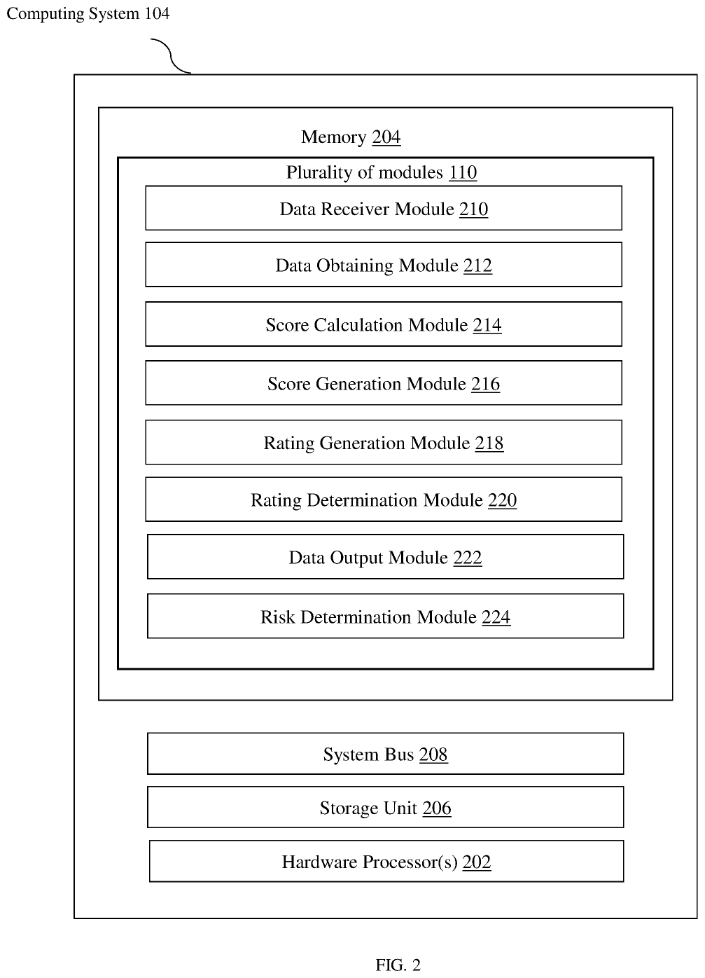

Furthermore, the one or more electronic devices 108 include a local browser, a mobile application or a combination thereof. Furthermore, the one or more users may use a web application via the local browser, the mobile application or a combination thereof to communicate with the computing system 104. In an embodiment of the present disclosure, the computing system 104 includes a plurality of modules 110. Details on the plurality of modules 110 have been elaborated in subsequent paragraphs of the present description with reference to FIG. 2.

In an embodiment of the present disclosure, the computing system 104 is configured to receive the set of equity raise metrics associated with the one or more companies from the external database 102. Further, the computing system 104 obtains a plurality of datapoints of the set of equity raises corresponding to the set of equity raise metrics from the external database 102. The computing system 104 calculates a set of z-scores corresponding to each of the plurality of datapoints associated with each of the one or more companies by applying a standardization technique on each of the obtained plurality of datapoints. The computing system 104 generates a set of scores for each of the set of equity raise metrics associated with the one or more companies based on the received set of equity raise metrics, the obtained plurality of datapoints and the calculated set of z-scores by using a min-max scaler. The computing system 104 determines the overall raise rating of each of the one or more companies by comparing the generated set of scores associated with the one or more companies with each other based on one or more rating parameters and a set of predefined rating rules. Further, the computing system 104 outputs the generated set of scores and the determined overall raise rating on user interface screen of the one or more electronic devices 108 associated with the one or more users.

FIG. 2 is a block diagram illustrating an exemplary computing system 104 for rating equity crowdfunding capital raises, in accordance with an embodiment of the present disclosure. Further, the computing system 104 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a data receiver module 210, a data obtaining module 212, a score calculation module 214, a score generation module 216, a rating generation module 218, a rating determination module 220, a data output module 222 and a risk determination module 224.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit may be a cloud storage. The storage unit may store the set of equity raise metrics, the plurality of datapoints and the set of z-scores. The storage unit 206 may also store the set of scores, the overall raise rating, the set of predefined rating rules, a set of risk metrics, a plurality of z-scores, a plurality of scores and an overall risk rating.

The data receiver module 210 is configured to receive the set of equity raise metrics associated with the one or more companies from the external database 102. In an embodiment of the present disclosure, the set of equity metrics are collected for one or more company raising capital, team, market financial, traction, competitors and the like. The one or more companies raise the set of equity raises. In an embodiment of the present disclosure, the set of equity raise metrics corresponds to information pertaining to the set of equity raises, such as price, market, team, differentiator and performance. The set of equity raises may be private equity raises. In an embodiment of the present disclosure, the one or more companies correspond to one or more start-ups, one or more smaller companies or a combination thereof. In an exemplary embodiment of the present disclosure, the set of equity raise metrics include a private equity raise metric price including one or more price parameters, a private equity raise metric market including one or more market parameters, a private equity raise metric team including one or more team parameters, a private equity raise metric differentiators including one or more differentiators parameters, a private equity raise metric performance including one or more performance parameters and the like. In an exemplary embodiment of the present disclosure, the one or more price parameters include valuation cap, pre-money-valuation, discount rate, security type and the like. Further, the one or more market parameters include addressable market size, market growth, market growth rate, revenue model, distribution model and the like. In an exemplary embodiment of the present disclosure, the one or more team parameters include founder's experience, number of relevant advisors, notable inventors, founder's education, execution track record, size of network, previous exits, whether founders have worked together previously, whether founders have complementary skill sets, diversity of team and the like. In an embodiment of the present disclosure, years of relevant industry experience, place of education, level of education, the size of network and previous exits associated with team, founders and other key members are considered as the one or more team parameters. In an embodiment of the present disclosure, the number of relevant advisors and notable investors as well as the diversity of the team is considered as the one or more team parameters as a whole. Furthermore, the one or more differentiators parameters include number of patents, number of direct competitors, whether company's product, service or a combination thereof has a higher quality and lower price compared to one or more competitor companies, barriers to entry, one or more business partnerships, margin level, capital intensity and the like. In an exemplary embodiment of the present disclosure, the one or more performance parameters include annual revenue or total annual revenue, monthly burn rate, growth since the last founding round, asset to liability ratio, number of users, number of paying customers, development phase and other financial metrics. For example, the development phase or current phase may be pre-launch, pre-revenue, pre-profit, profitable and the like.

The data obtaining module 212 is configured to obtain the plurality of datapoints of the set of equity raises corresponding to the set of equity raise metrics from the external database 102. According to some embodiments, the data points include data sourced from the SEC website such as the company's financial statements and data sources from the raise pages of companies on crowdfunding platforms such as valuation, valuation cap, target market size, number of competitors, and market share. In an exemplary embodiment of the present disclosure, the plurality of datapoints include a set of price data points, a set market data points, a set of team data points, a set of differentiators data points, a set of performance data points and the like.

The score calculation module 214 is configured to calculate the set of z-scores corresponding to each of the plurality of datapoints associated with each of the one or more companies by applying the standardization technique, such as z-score standardization, and then applying the Standard Normal Cumulative Distribution Function on the z-scores on each of the obtained plurality of datapoints.

The score generation module 216 is configured to generate the set of scores or set of ratings for each of the set of equity raise metrics associated with the one or more companies based on the received set of equity raise metrics, the obtained plurality of datapoints and the calculated set of z-scores by using the min-max scaler. In generating the set of scores for each of the set of equity raise metrics associated with the one or more companies based on the received set of equity raise metrics, the obtained plurality of datapoints and the calculated set of z-scores by using the min-max scaler, the score generation module 216 generates a set of ranks for each of the set of z-scores corresponding to each of the plurality of datapoints by applying a normal distribution function on the set of z-scores. In an embodiment of the present disclosure, the set of ranks are generated to rank the set of z-scores against each other. Further, the score generation module 216 converts the set of ranks to the set of scores by using the min-max scaler. In an embodiment of the present disclosure, the set of scores ranges from one to five. In an embodiment of the present disclosure, the set of scores are generated for each of the one or more price parameters, the one or more market parameters, the one or more team parameters, the one or more differentiators parameters and the one or more performance parameters. For example, for generating the set of scores for the private equity raise metric price including the one or more price parameters, the set of price data points of the set of equity raises are standardized by calculating corresponding z-scores and then normalized by using normal distribution technique in preparation to rank all those values against each other. Further, a min-max scaler is used to convert the ranks to score between one and five. The score includes valuation cap score, pre-money-valuation score, discount rate score, security type score and the like. The private equity raise metric price including the one or more price parameters are stored in the storage unit. In an embodiment of the present disclosure, the valuation of a company at current round is compared to valuations of each of the one or more other companies raising at a same time and at a same company stage. Further, if current round is raised on a convertible note or a Simple Agreement for Future Equity (SAFE), one or more valuation caps, and one or more discount rates are compared for the private equity raise metric price. A company with a higher valuation is allocated with a lower score. Further, industry-specific revenue multiples of a company are compared to one or more other companies in same industry and valuation growth over time. In another example, for generating the set of scores for the private equity raise metric market including the one or more market parameters, the set of market data points of the set of equity raises are standardized by calculating corresponding z-scores and then normalized by using normal distribution technique in preparation to rank all those values against each other. Further, a min-max scaler is used to convert the ranks to score between one and five. The score includes addressable market size score, market growth score, market growth rate score, distribution model score, revenue model score and the like. The private equity raise metric market including the one or more market parameters are stored in the storage unit. In an embodiment of the present disclosure, a standard market size is researched to estimate addressable markets and the market growth rates. The one or more companies with bigger market sizes or faster growing markets obtain higher scores for the metric.

Further, for example, for generating the set of scores for the private equity raise metric team including the one or more team parameters, the set of team data points of the set of equity raises are standardized by calculating corresponding z-scores and then normalized by using normal distribution technique in preparation to rank all those values against each other. Further, a min-max scaler is used to convert the ranks to score between one and five. The score includes diversity score, execution score, experience score, network score and the like. The private equity raise metric team including the one or more team parameters are stored in the storage unit. For example, for generating the set of scores for the private equity raise metric differentiators including the one or more differentiators parameters, the set of differentiators data points of the set of equity raises are standardized by calculating corresponding z-scores and then normalized by using normal distribution technique in preparation to rank all those values against each other. Further, a min-max scaler is used to convert the ranks to score between one and five. The score includes competition score, defensibility score, product differentiation score and the like. The private equity raise metric differentiators including the one or more differentiators parameters are stored in the storage unit. Furthermore, in another example, for generating the set of scores for the private equity raise metric performance including the one or more performance parameters, the set of performance data points of the set of equity raises are standardized by calculating corresponding z-scores and then normalized by using normal distribution technique in preparation to rank all those values against each other. Further, a min-max scaler is used to convert the ranks to score between one and five. The score includes annual revenue, monthly burn rate, development phase, asset to liability ratio and the like. The private equity raise metric performance including the one or more performance parameters are stored in the storage unit.

In an embodiment of the present disclosure, the rating generation module 218 is configured to generate the overall rating for each of the set of equity raise metrics associated with the one or more companies based on the received set of equity raise metrics, the obtained plurality of datapoints and the generated set scores by computing average of the generated set scores. In an embodiment of the present disclosure, the overall rating for each of the set of equity raise metrics include price rating, market rating, team rating, differentiation rating, performance rating and the like. In an embodiment of the present disclosure, the overall rating for each of the set of equity raise metrics associated with the one or more companies are generated by comparing the plurality of datapoints associated with the one or more companies with each other.

The rating determination module 220 is configured to determine the overall raise rating of each of the one or more companies by comparing the generated set of scores associated with the one or more companies with each other based on the one or more rating parameters and the set of predefined rating rules. In an embodiment of the present disclosure, the overall raise rating of a company is calculated by taking average of the overall rating for each of the set of equity raise metrics. The average also goes through the same process of standardization by calculating corresponding z-scores and then being normalized by using normal distribution technique in preparation to rank all those values against each other. Further, a min-max scaler is used to convert the ranks to score between one and five.

As such, the rating changes for the company raises still active. For example, companies take multiple months to close their funding rounds, thus, many of them will overlap. We only include companies that are still actively raising in our calculations. When a company closes its funding round, we freeze its score and take it out of the pool of active companies. When new companies are added to the pool, or closed companies are removed from the pool. This will be reflected on the comparable scores for companies that were already still inside the pool. In an embodiment of the present disclosure, the overall raise rating for each of the one or more companies raises is determined by comparing each of the one or more companies' raise with all other company raises or other company raises in a specific industry. When a company raise closes, raise data associated with the one or more companies, such as the set of equity raise metrics, the plurality of datapoints, the overall raise rating, the overall risk rating and the like, is still used for all active raises. The last date the raise was active is rating used for a raise.

The data output module 222 is configured to output the generated set of scores and the determined overall raise rating on user interface screen of the one or more electronic devices 108 associated with the one or more users. In an embodiment of the present disclosure, the one or more users are one or more individual investors who desire to invest in start-ups and the smaller companies. In an exemplary embodiment of the present disclosure, the one or more electronic devices 108 may include a laptop computer, desktop computer, tablet computer, smartphone, wearable device, smart watch and the like.

In an embodiment of the present disclosure, the data output module 222 also outputs one or more attributes associated with each of the set of equity raise metrics on user interface screen of the one or more electronic devices 108 associated with the one or more users. To add more info on these attributes, we show some data points on the interface that are of interest to the user (who is the investor) that are not included in the quantitative algorithm, but are added just for reference. In an exemplary embodiment of the present disclosure, the one or more attributes associated with the private equity raise metric price include security type, stage, series and the like. For example, security type may be sage, stage may be early, series may be pre-seed and the like. In an exemplary embodiment of the present disclosure, the one or more attributes associated with the private equity raise metric market include revenue model, distribution model, business model, market regulation, market has established competitors, target market type, market growth rate and the like. Further, the one or more attributes associated with the private equity raise metric team include number of founders, number of employees, founders have shared experience, founders have complimentary skills, founders have previous exits and the like. In an exemplary embodiment of the present disclosure, the one or more attributes associated with the private equity raise metric differentiators include has patents, barriers to entry, margin level, capital intensity and the like. Furthermore, the one or more attributes associated with the private equity raise metric performance include development phase and the like.

The risk determination module 224 receives the set of risk metrics associated with the one or more companies from the external database 102. In an exemplary embodiment of the present disclosure, the set of risk metrics include product risk, team risk, market risk, legal risk, funding risk, investment terms risk, time risk, financial risk and the like. Further, the risk determination module 224 obtains the set of risk datapoints of the set of equity raises corresponding to the set of risk metrics from the external database 102. The risk determination module 224 calculates the plurality of z-scores corresponding to each of the set of risk datapoints associated with each of the one or more companies by applying the standardization technique on each of the obtained set of risk datapoints. Furthermore, the risk determination module 224 generates the plurality of scores for each of the set of risk metrics associated with the one or more companies based on the received set of risk metrics, the obtained set of risk datapoints and the calculated plurality of z-scores by using the min-max scaler. In generating the plurality of scores for each of the set of risk metrics associated with the one or more companies based on the received set of risk metrics, the obtained set of risk datapoints and the calculated plurality of z-scores by using the min-max scaler, the risk determination module 224 generate a plurality of ranks for each of the plurality of z-scores corresponding to each of the set of risk datapoints by applying the normal distribution function on the plurality of z-scores. In an embodiment of the present disclosure, the plurality of ranks are generated to rank the plurality of z-scores against each other. Further, the risk determination module 224 converts the plurality of ranks to the plurality of scores by using the min-max scaler. In an exemplary embodiment of the present disclosure, the plurality of scores ranges from one to five. The risk determination module 224 determines the overall risk rating of each of the one or more companies by comparing the generated plurality of scores associated with the one or more companies with each other based on the one or more rating parameters and the set of predefined rating rules. Furthermore, the risk determination module 224 outputs the plurality of scores and the determined overall risk rating on user interface screen of the one or more electronic devices 108 associated with the one or more users.

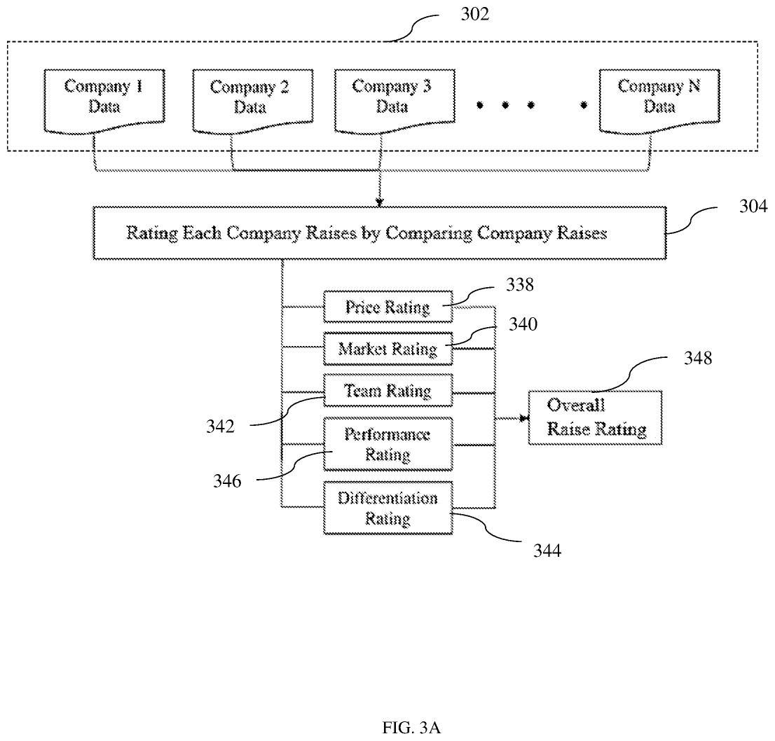

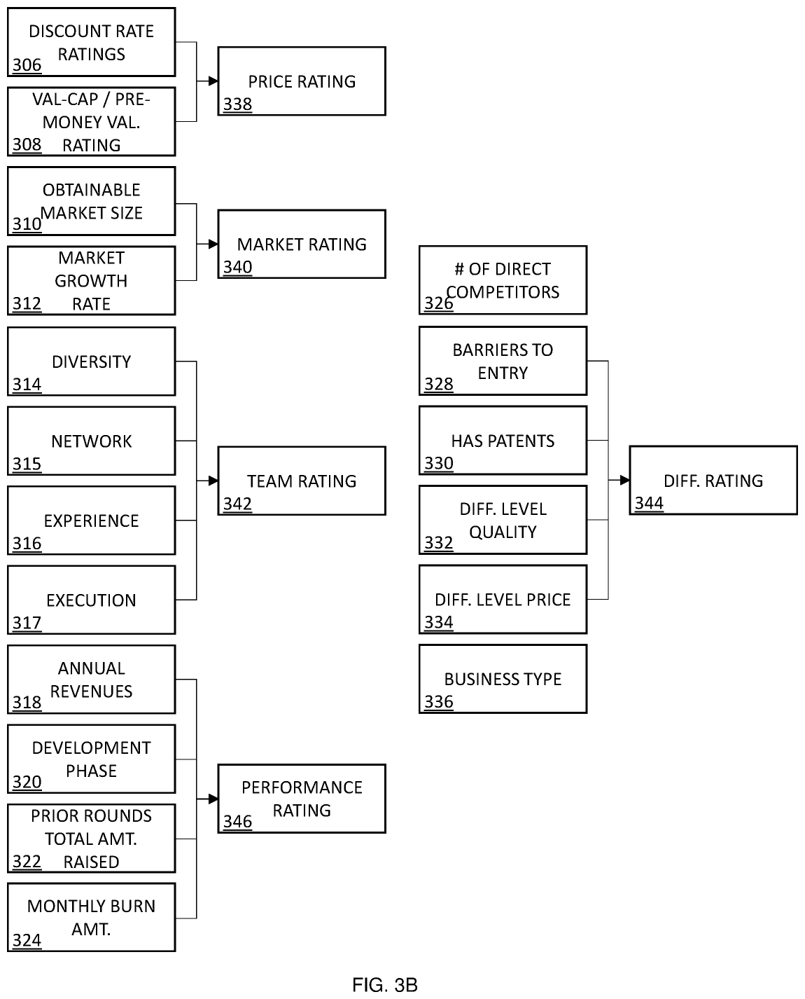

FIG. 3A is a block diagram illustrating an exemplary set of steps for determining overall raise rating associated with one or more companies, in accordance with an embodiment of the present disclosure. Further, FIG. 3B is a block diagram illustrating an exemplary set of steps of generating overall rating for each of set of equity raise metrics and overall raise rating associated with the one or more companies, in accordance with an embodiment of the present disclosure. For the sake of brevity, FIGS. 3A-3B have been explained together. In an embodiment of the present disclosure, FIGS. 3A-3B depict operation of the computing system 104. At 302, data associated with the set of equity raises raised by the one or more companies i.e., the set of equity metrics and the plurality of datapoints, is obtained from the external database 102, as shown in FIG. 3A. In an embodiment of the present disclosure, overall raise rating for each the set of equity raises done by the one or more companies is determined by comparison of each company raises with all other company raises or other company raises in a specific industry or growth stage, at 304. Further, the set of z-scores corresponding to each of the plurality of datapoints associated with each of the one or more companies are calculated by applying the standardization technique on each of the obtained plurality of datapoints. Furthermore, the set of scores/the set of ratings for each of the set of equity raise metrics associated with the one or more companies are generated based on the set of equity raise metrics, the obtained plurality of datapoints and the calculated set of z-scores by using the min-max scaler. In an embodiment of the present disclosure, the set of scores/the set of ratings corresponds to scores of each of the one or more price parameters, the one or more market parameters, the one or more team parameters, the one or more differentiators parameters and the one or more performance parameters for evaluating overall rating for each of the set of equity raise metrics. For example, discount rate ratings 306 and valuation cap or pre-money-evaluation rating 308 are generated corresponding to the private equity raise metric price, as shown in FIG. 3B. Similarly, obtainable market size score 310 and market growth rate score 312 are generated corresponding to the private equity raise metric market.

Continuing with FIG. 3B, in an exemplary embodiment of the present disclosure, a relative diversity score 314, a network score 315, a relative experience score 316, and a historical execution score 317 are generated corresponding to the private equity raise metric team. Further, the set of scores associated with annual revenue 318, development phase 320, prior rounds total amount raised 322 and monthly burn amount 324 are generated corresponding to the private equity raise metric performance. Furthermore, the set of scores associated with number of direct competitors 326, barrier to entry 328, number of patents 330, differentiation level quality 332, differentiation level price 334 and business type 336 are generated corresponding to the private equity raise metric differentiators. Further, the overall rating for each of the set of equity raise metrics associated with the one or more companies is generated based on the set of equity raise metrics, the obtained plurality of datapoints and the generated set scores by computing average of the generated set scores. In an embodiment of the present disclosure, the overall rating for each of the set of equity raise metrics include five main metrics i.e., price rating 338, market rating 340, team rating 342, differentiation rating 344 and performance rating 346 for rating each of the one or more companies, as shown in FIG. 3A-3B. In an embodiment of the present disclosure, the overall rating for each of the set of equity raise metrics associated with the one or more companies by comparing the plurality of datapoints associated with the one or more companies with each other. Furthermore, the overall raise rating 348 of each of the one or more companies is determined by comparing the generated set of scores associated with the one or more companies with each other based on the one or more rating parameters and the set of predefined rating rules. In an embodiment of the present disclosure, the overall raise rating 348 of a company is calculated by taking average of the overall rating for each of the set of equity raise metrics i.e., the price rating 338, market rating 340, differentiation rating 344, performance rating 345, and team rating 342. The average also goes through the same process of standardization by calculating corresponding z-scores and then normalized by using normal distribution technique in preparation to rank all those values against each other. Further, a min-max scaler is used to convert the ranks to score between one and five. The result is a positively skewed distribution. In addition to the ratings, the median for the five metrics, the overall raise rating 348 and each individual rating components median value is calculated. When a company raise closes, the raise data is still used for all active raises. The last date the raise may be active is the rating used for a raise. Further, the generated set of scores, overall rating for each of the set of equity raise metrics and the determined overall raise rating 348 are outputted on user interface screen of the one or more electronic devices 108 associated with the one or more users.

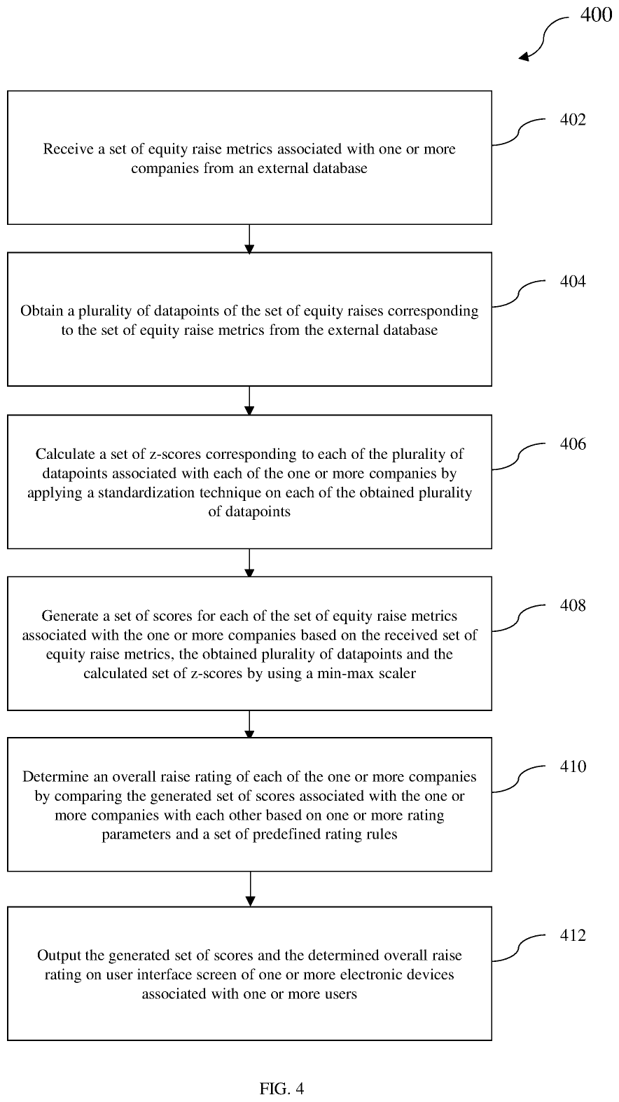

FIG. 4 is a process flow diagram illustrating an exemplary method for rating equity crowdfunding capital raises, in accordance with an embodiment of the present disclosure. At step 402, a set of equity raise metrics associated with one or more companies are received from an external database 102. In an embodiment of the present disclosure, the set of equity metrics are collected for one or more company raising capital, team, market financial, traction, competitors and the like. The one or more companies raise the set of equity raises. In an embodiment of the present disclosure, the set of equity raise metrics corresponds to information pertaining to the set of equity raises, such as price, market, team, differentiator and performance. The set of equity raises may be private equity raises. In an embodiment of the present disclosure, the one or more companies correspond to one or more start-ups, one or more smaller companies or a combination thereof. In an exemplary embodiment of the present disclosure, the set of equity raise metrics include a private equity raise metric price including one or more price parameters, a private equity raise metric market including one or more market parameters, a private equity raise metric team including one or more team parameters, a private equity raise metric differentiators including one or more differentiators parameters, a private equity raise metric performance including one or more performance parameters and the like. In an exemplary embodiment of the present disclosure, the one or more price parameters include valuation cap, pre-money-valuation, discount rate, security type and the like. Further, the one or more market parameters include addressable market size, market growth, market growth rate, revenue model, distribution model and the like. In an exemplary embodiment of the present disclosure, the one or more team parameters include founder's experience, number of relevant advisors, notable inventors, founder's education, execution track record, size of network, previous exits, whether founders have worked together previously, whether founders have complementary skill sets, diversity of team and the like. In an embodiment of the present disclosure, years of relevant industry experience, place of education, level of education, the size of network and previous exits associated with team, founders and other key members are considered as the one or more team parameters. In an embodiment of the present disclosure, the number of relevant advisors and notable investors as well as the diversity of the team is considered as the one or more team parameters as a whole. Furthermore, the one or more differentiators parameters include number of patents, number of direct competitors, whether company's product, service or a combination thereof has a higher quality and lower price compared to one or more competitor companies, barriers to entry, one or more business partnerships, margin level, capital intensity and the like. In an exemplary embodiment of the present disclosure, the one or more performance parameters include annual revenue or total annual revenue, monthly burn rate, growth since the last founding round, asset to liability ratio, number of users, number of paying customers, development phase and other financial metrics. For example, the development phase or current phase may be pre-launch, pre-revenue, pre-profit, profitable and the like.

At step 404, a plurality of datapoints of the set of equity raises corresponding to the set of equity raise metrics are obtained from the external database 102. In an exemplary embodiment of the present disclosure, the plurality of datapoints include a set of price data points, a set market data points, a set of team data points, a set of differentiators data points, a set of performance data points and the like.

At step 406, a set of z-scores corresponding to each of the plurality of datapoints associated with each of the one or more companies are calculated by applying a standardization technique on each of the obtained plurality of datapoints.

At step 408, a set of scores are generated for each of the set of equity raise metrics associated with the one or more companies based on the received set of equity raise metrics, the obtained plurality of datapoints and the calculated set of z-scores by using a min-max scaler. In generating the set of scores for each of the set of equity raise metrics associated with the one or more companies based on the received set of equity raise metrics, the obtained plurality of datapoints and the calculated set of z-scores by using the min-max scaler, the method 400 includes generating a set of ranks for each of the set of z-scores corresponding to each of the plurality of datapoints by applying a normal distribution function on the set of z-scores. In an embodiment of the present disclosure, the set of ranks are generated to rank the set of z-scores against each other. Further, the method 400 includes converting the set of ranks to the set of scores by using the min-max scaler. In an embodiment of the present disclosure, the set of scores ranges from one to five. In an embodiment of the present disclosure, the set of scores are generated for each of the one or more price parameters, the one or more market parameters, the one or more team parameters, the one or more differentiators parameters and the one or more performance parameters. For example, for generating the set of scores for the private equity raise metric price including the one or more price parameters, the set of price data points of the set of equity raises are standardized by calculating corresponding z-scores and then normalized by using normal distribution technique in preparation to rank all those values against each other. Further, a min-max scaler is used to convert the ranks to score between one and five. The score includes valuation cap score, pre-money-valuation score, discount rate score, security type score, and the like. The private equity raise metric price including the one or more price parameters are stored in the storage unit. In an embodiment of the present disclosure, the valuation of a company at current round is compared to valuations of each of the one or more other companies raising at a same time and at a same company stage. Further, if current round is raised on a convertible note or a Simple Agreement for Future Equity (SAFE), one or more valuation caps, and one or more discount rates are compared for the private equity raise metric price. A company with a higher valuation is allocated with a lower score. Further, industry-specific revenue multiples of a company are compared to one or more other companies in same industry and valuation growth over time. In another example, for generating the set of scores for the private equity raise metric market including the one or more market parameters, the set of market data points of the set of equity raises are standardized by calculating corresponding z-scores and then normalized by using normal distribution technique in preparation to rank all those values against each other. Further, a min-max scaler is used to convert the ranks to score between one and five. The score includes addressable market size score, market growth score, market growth rate score, distribution model score, revenue model score and the like. The private equity raise metric market including the one or more market parameters are stored in the storage unit. In an embodiment of the present disclosure, a standard market size is researched to estimate addressable markets and the market growth rates. The one or more companies with bigger market sizes or faster growing markets obtain higher scores for the metric.

Further, for example, for generating the set of scores for the private equity raise metric team including the one or more team parameters, the set of team data points of the set of equity raises are standardized by calculating corresponding z-scores and then normalized by using normal distribution technique in preparation to rank all those values against each other. Further, a min-max scaler is used to convert the ranks to score between one and five. The score includes diversity score, execution score, experience score, network score and the like. The private equity raise metric team including the one or more team parameters are stored in the storage unit. For example, for generating the set of scores for the private equity raise metric differentiators including the one or more differentiators parameters, the set of differentiators data points of the set of equity raises are standardized by calculating corresponding z-scores and then normalized by using normal distribution technique in preparation to rank all those values against each other. Further, a min-max scaler is used to convert the ranks to score between one and five. The score includes competition score, defensibility score, product differentiation score and the like. The private equity raise metric differentiators including the one or more differentiators parameters are stored in the storage unit. Furthermore, in another example, for generating the set of scores for the private equity raise metric performance including the one or more performance parameters, the set of performance data points of the set of equity raises are standardized by calculating corresponding z-scores and then normalized by using normal distribution technique in preparation to rank all those values against each other. Further, a min-max scaler is used to convert the ranks to score between one and five. The score includes annual revenue, monthly burn rate, development phase, asset to liability ratio and the like. The private equity raise metric performance including the one or more performance parameters are stored in the storage unit.

In an embodiment of the present disclosure, the method 400 includes generating an overall rating for each of the set of equity raise metrics associated with the one or more companies based on the received set of equity raise metrics, the obtained plurality of datapoints and the generated set scores by computing average of the generated set scores. In an embodiment of the present disclosure, the overall rating for each of the set of equity raise metrics include price rating 338, market rating 340, team rating 342, differentiation rating 344, performance rating 346 and the like. In an embodiment of the present disclosure, the overall rating for each of the set of equity raise metrics associated with the one or more companies are generated by comparing the plurality of datapoints associated with the one or more companies with each other.

At step 410, an overall raise rating 348 of each of the one or more companies is determined by comparing the generated set of scores associated with the one or more companies with each other based on one or more rating parameters and a set of predefined rating rules. In an embodiment of the present disclosure, the overall raise rating 348 of a company is calculated by taking average of the overall rating for each of the set of equity raise metrics. The average also goes through the same process of standardization by calculating corresponding z-scores and then normalized by using normal distribution technique in preparation to rank all those values against each other. Further, a min-max scaler is used to convert the ranks to score between one and five. For example, the set of predefined rating rules include company with a higher valuation is allocated with a lower score, the one or more companies with bigger market sizes or faster growing markets obtain higher scores for metric and the like. In an embodiment of the present disclosure, the overall rating for each of the set of equity raise metrics associated with the one or more companies are also compared with each other to determine the overall raise rating 348 of each of the one or more companies. In an exemplary embodiment of the present disclosure, the one or more rating parameters include company industry, growth stage, all companies raising private equity or a combination thereof. In an embodiment of the present disclosure, overall raise rating 348 of each of the one or more companies may vary from week to week. Every week, new companies are raising money and other companies have closed their funding rounds. As such, the rating changes for the company raises still active. In an embodiment of the present disclosure, the overall raise rating 348 for each of the one or more companies raises is determined by comparing each of the one or more companies' raise with all other company raises or other company raises in a specific industry. When a company raise closes, raise data associated with the one or more companies, such as the set of equity raise metrics, the plurality of datapoints, the overall raise rating 348, the overall risk rating and the like, is still used for all active raises. The last date the raise was active is rating used for a raise.

At step 412, the generated set of scores and the determined overall raise rating 348 are outputted on user interface screen of one or more electronic devices 108 associated with one or more users. In an embodiment of the present disclosure, the one or more users are one or more individual investors who desire to invest in start-ups and the smaller companies. In an exemplary embodiment of the present disclosure, the one or more electronic devices 108 may include a laptop computer, desktop computer, tablet computer, smartphone, wearable device, smart watch and the like.

In an embodiment of the present disclosure, one or more attributes associated with each of the set of equity raise metrics along with their corresponding final scores are outputted on user interface screen of the one or more electronic devices 108 associated with the one or more users. In an exemplary embodiment of the present disclosure, the one or more attributes associated with the private equity raise metric price include security type, stage, series and the like. For example, security type may be sage, stage may be early, series may be pre-seed and the like. In an exemplary embodiment of the present disclosure, the one or more attributes associated with the private equity raise metric market include revenue model, distribution model, business model, market regulation, market has established competitors, target market type, market growth rate and the like. Further, the one or more attributes associated with the private equity raise metric team include number of founders, number of employees, founders have shared experience, founders have complimentary skills, founders have previous exits and the like. In an exemplary embodiment of the present disclosure, the one or more attributes associated with the private equity raise metric differentiators include has patents, barriers to entry, margin level, capital intensity and the like. Furthermore, the one or more attributes associated with the private equity raise metric performance include development phase and the like.

Further, the AI based method 400 includes receiving a set of risk metrics associated with the one or more companies from the external database 102. In an exemplary embodiment of the present disclosure, the set of risk metrics include product risk, team risk, market risk, legal risk, funding risk, investment terms risk, time risk, financial risk and the like. Further, the method 400 includes obtaining the set of risk datapoints of the set of equity raises corresponding to the set of risk metrics from the external database 102. The method 400 includes calculating the plurality of z-scores corresponding to each of the set of risk datapoints associated with each of the one or more companies by applying the standardization technique on each of the obtained set of risk datapoints. Furthermore, the method 400 includes generating the plurality of scores for each of the set of risk metrics associated with the one or more companies based on the received set of risk metrics, the obtained set of risk datapoints and the calculated plurality of z-scores by using the min-max scaler. In generating the plurality of scores for each of the set of risk metrics associated with the one or more companies based on the received set of risk metrics, the obtained set of risk datapoints and the calculated plurality of z-scores by using the min-max scaler, the method 400 includes generating a plurality of ranks for each of the plurality of z-scores corresponding to each of the set of risk datapoints by applying the normal distribution function on the plurality of z-scores. In an embodiment of the present disclosure, the plurality of ranks are generated to rank the plurality of z-scores against each other. Further, the method 400 includes converting the plurality of ranks to the plurality of scores by using the min-max scaler. In an exemplary embodiment of the present disclosure, the plurality of scores ranges from one to five. The method 400 includes determining the overall risk rating of each of the one or more companies by comparing the generated plurality of scores associated with the one or more companies with each other based on the one or more rating parameters and the set of predefined rating rules. Furthermore, the method 400 includes outputting the plurality of scores and the determined overall risk rating on user interface screen of the one or more electronic devices 108 associated with the one or more users.

The AI based method 400 may be implemented in any suitable hardware, software, firmware, or combination thereof.

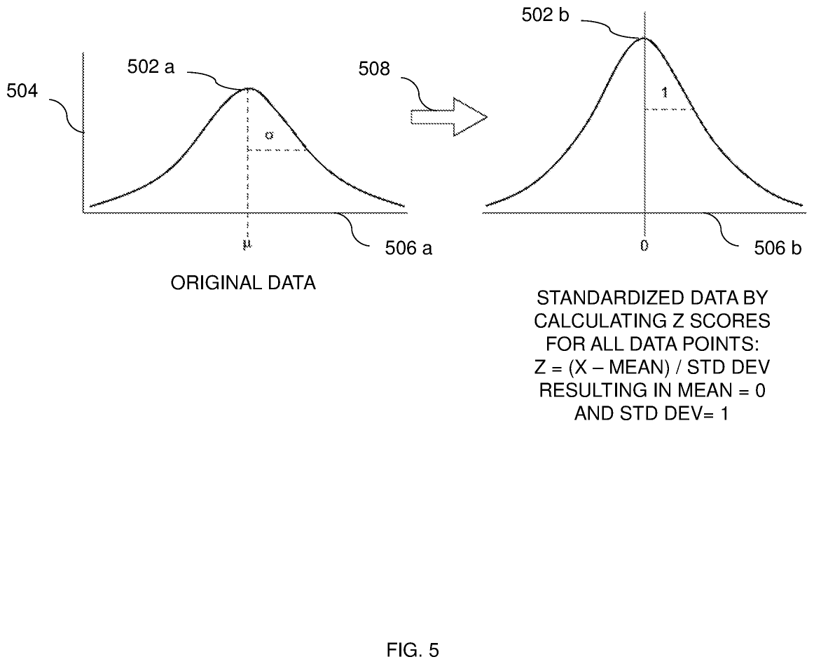

FIG. 5 is an exemplary graph illustrating a sample data processing, in accordance with an embodiment of the present disclosure. In an embodiment of the present disclosure, a sample data is standardized by using the standardization technique. Further, the standardized data is normalized by applying the min-max scaler.

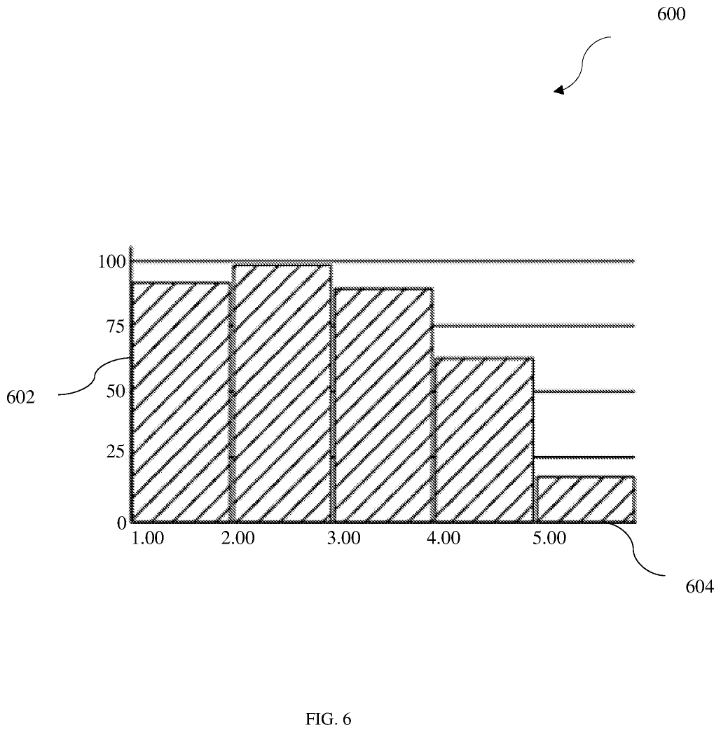

FIG. 6 is an exemplary graph 600 illustrating a sample overall rating of one or more company's raises showing a positively skewed distribution, in accordance with an embodiment of the present disclosure. FIG. 6 shows a graph of standardized data derived by calculating z-scores for all data points such that z=(X−mean)/standard deviation, thus resulting in a mean=0 and a standard deviation=1.

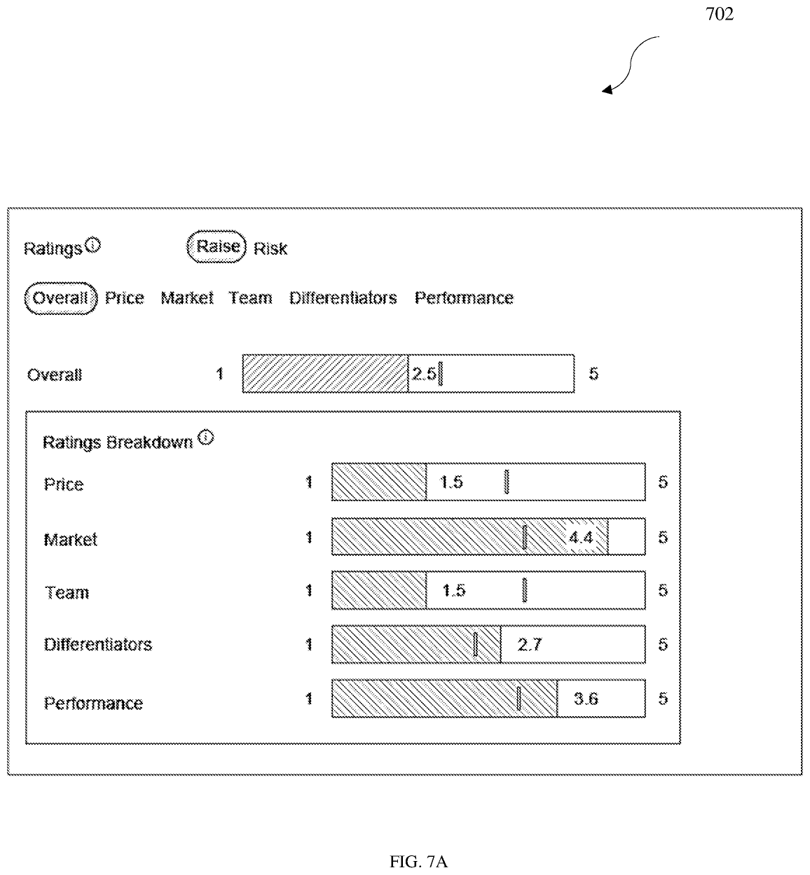

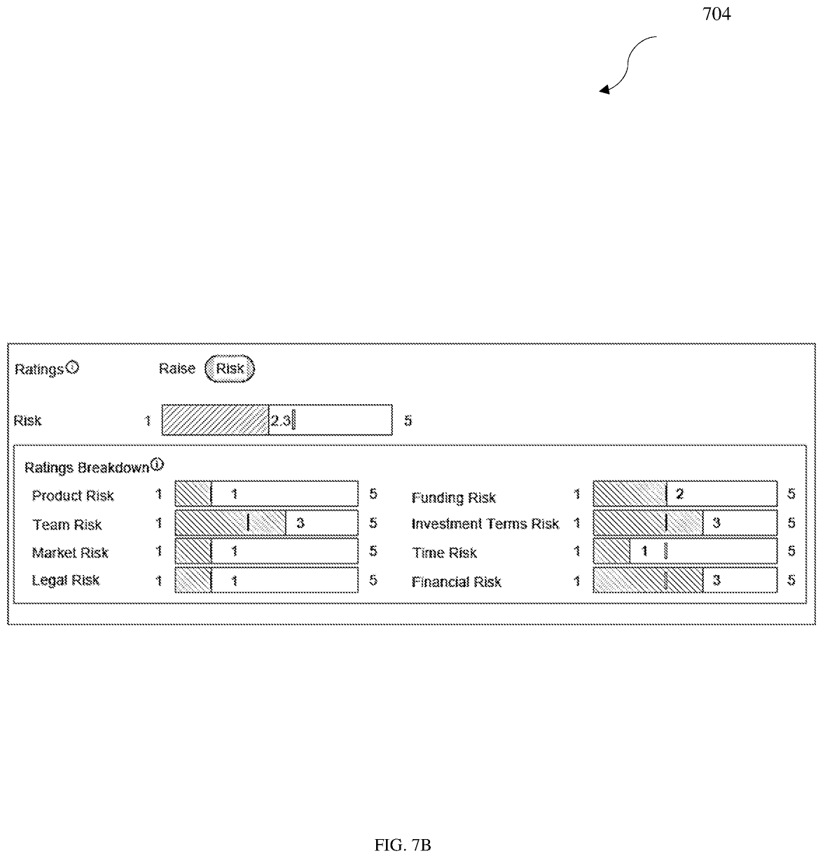

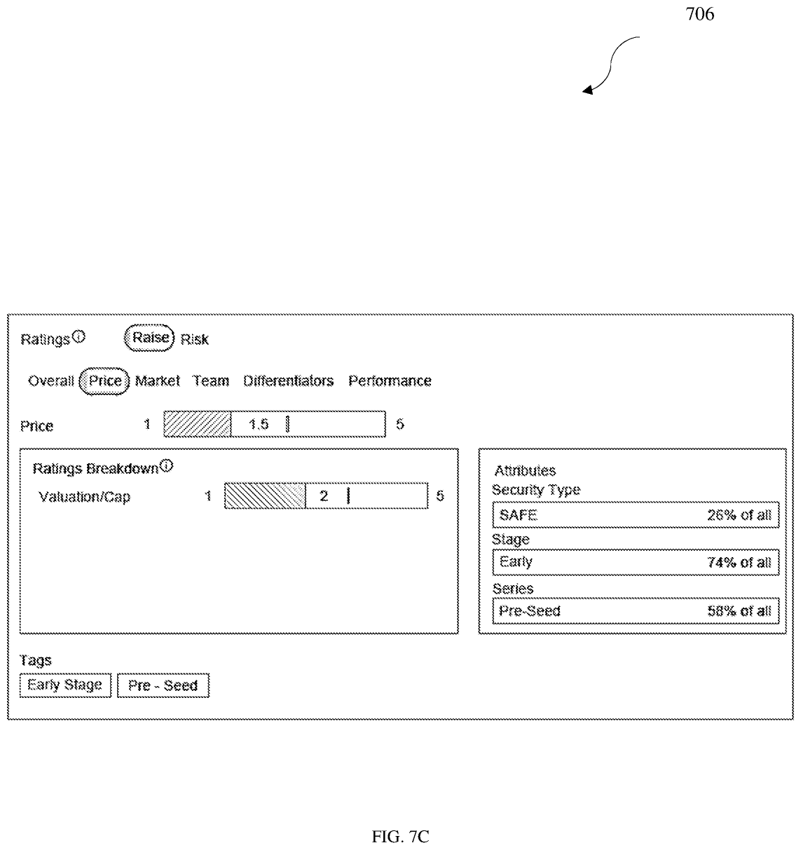

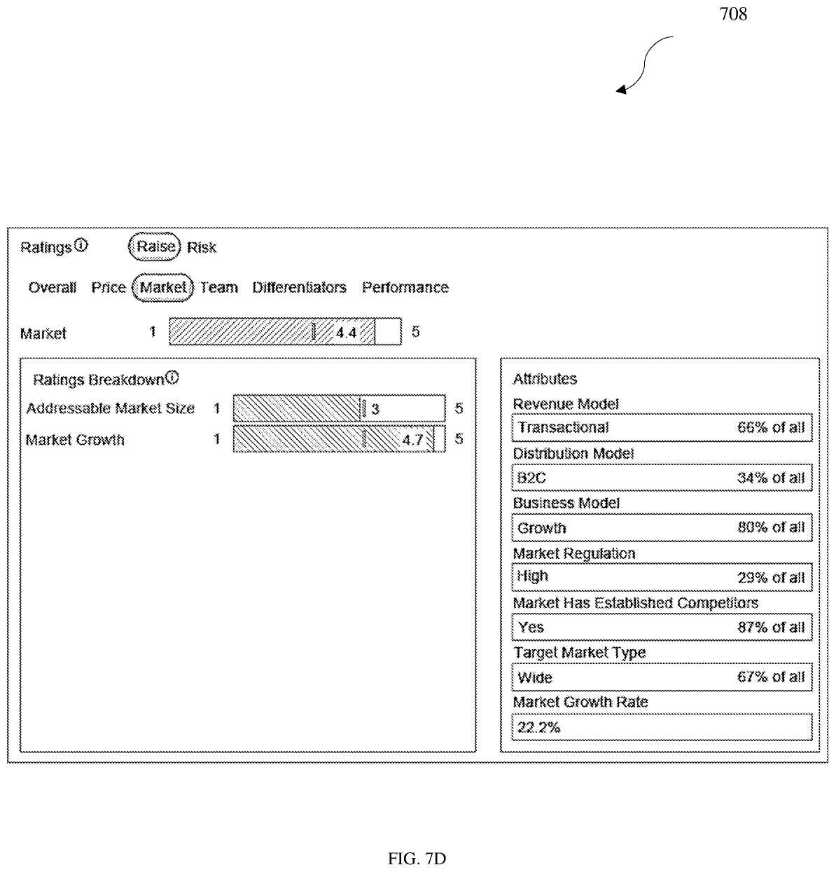

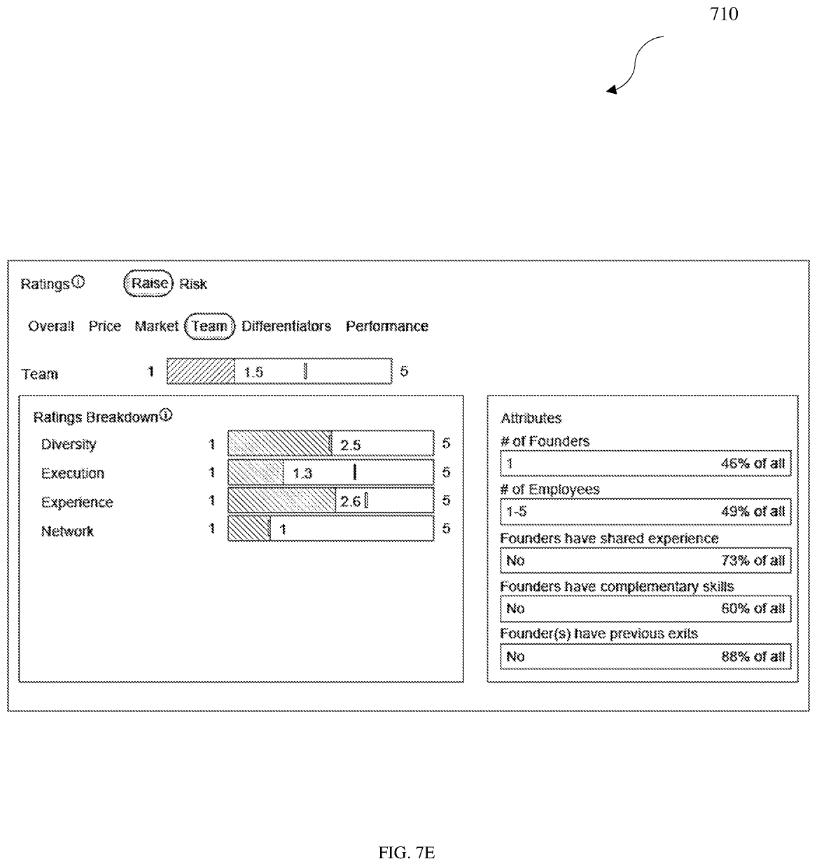

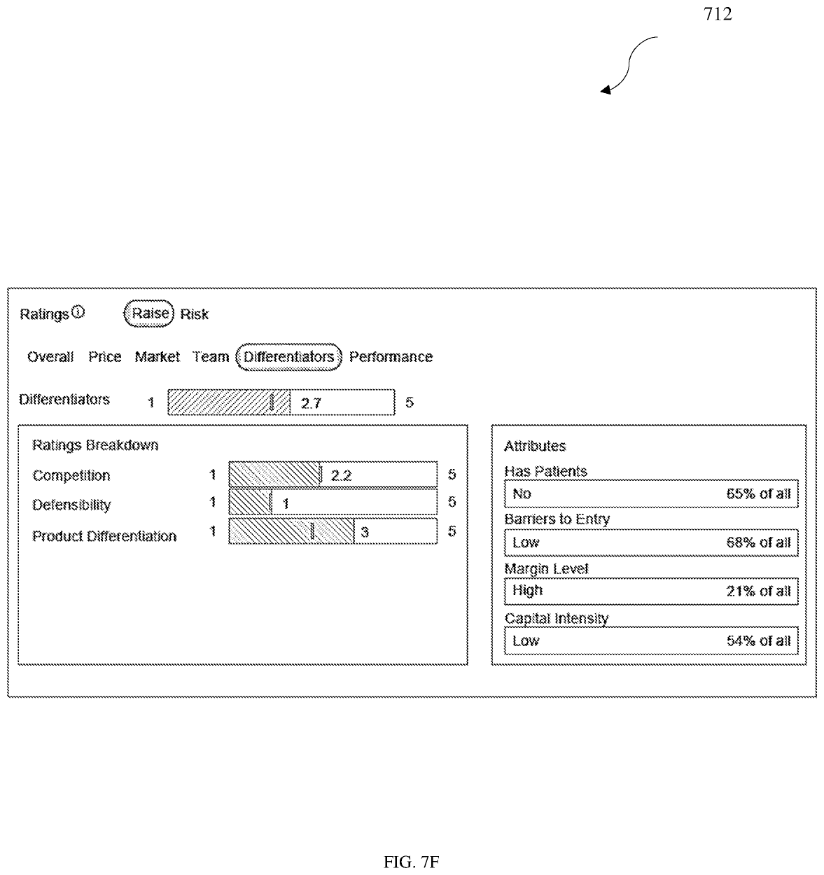

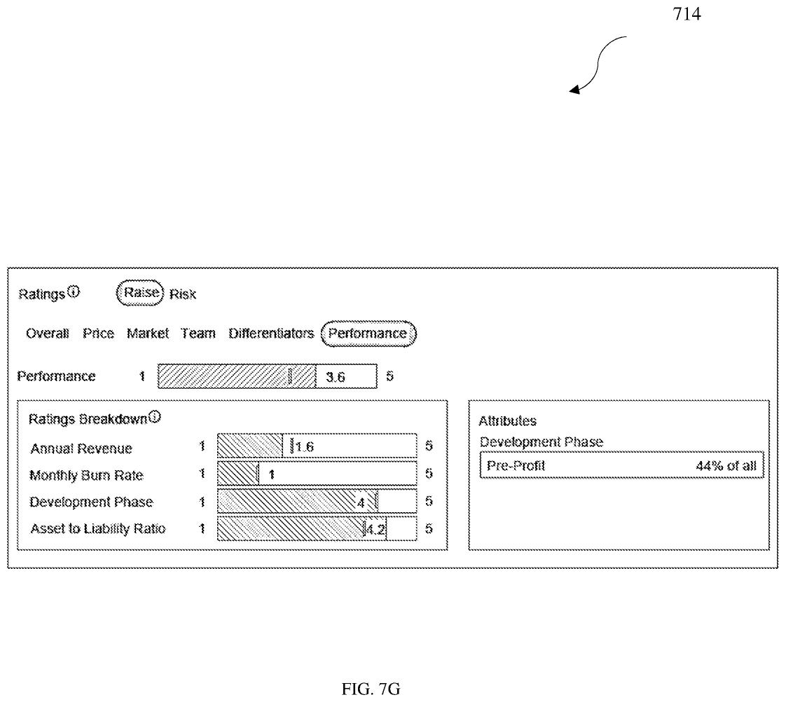

FIGS. 7A-7G are graphical user interface screens of dashboard of the computing system 104 for rating equity crowdfunding capital raises, in accordance with an embodiment of the present disclosure. FIG. 7A is a graphical user interface screen 702 showing the overall rating for each of the set of equity raise metrics and the overall raise rating of each of the one or more companies for equity crowdfunding capital raises by independently comparing the one or more companies or start-up's raises to each other. For example, the overall raise rating is 2.5, price rating is 1.5, market rating is 4.4, team rating is 1.5, differentiators rating is 2.7 and performance rating is 3.6, as shown in FIG. 7A. FIG. 7B is a graphical user interface screen 704 showing the plurality of scores for each of the set of risk metrics and the overall risk rating of each of the one or more companies for equity crowdfunding capital raises by independently comparing the one or more companies or start-up's raises to each other. For example, the overall risk rating is 2.3, product risk rating is 1, team risk rating is 3, market risk rating is 1, legal risk rating is 1, funding risk rating is 2, investment terms risk rating is 3, time risk rating is 1 and financial risk rating is 3. FIG. 7C is a graphical user interface screen 706 showing the set of scores for the private equity raise metric price including the one or more price parameters and the one or more attributes. For example, the price rating is 1.5, valuation/cap rating is 2, security type is safe, stage is early and series is pre-seed. FIG. 7D is a graphical user interface screen 708 showing the set of scores for the private equity raise metric market including the one or more market parameters and the one or more attributes. For example, the market rating is 4.4, addressable market size rating is 1.5, market growth rating is 4.7, revenue model is transactional, distribution model is B2C, business model is growth, market regulation is high and the like. FIG. 7E is a graphical user interface screen 710 showing the set of scores for the private equity raise metric team including the one or more team parameters and the one or more attributes. For example, the team rating is 1.5, diversity rating is 2.5, execution rating is 1.3, experience rating is 2.6, network rating is 1, number of founders is 1, number of employees are 1-5 and the like. FIG. 7F is a graphical user interface screen 712 showing the set of scores for the private equity raise metric differentiators including the one or more differentiators parameters and the one or more attributes. For example, the differentiation rating is 2.7, competition rating is 2.2, defensibility rating is 1, product differentiation rating is 3, barriers to entry are no, margin level is high, capital intensity is low and the like. FIG. 7G is a graphical user interface screen 714 showing the set of scores for the private equity raise metric market performance the one or more performance parameters and the one or more attributes. For example, the performance rating is 3.5, annual revenue rating is 1.6, monthly burn rate rating is 1, development phase rating is 4, asset to liability ratio rating is 4.2, development phase is pre-profit and the like.

Thus, various embodiments of the present computing system 104 provide a solution to rate equity crowdfunding capital raises. In an embodiment of the present disclosure, the computing system 104 rates equity crowdfunding capital raises by independently comparing start-ups or one or more companies with each other. Further, the computing system 104 provides new and valuable information that can be used by inexperienced or expert investors to help guide investment decisions. The computing system 104 provides a statistically based investment rating method and system whereby relative ratings are generated using a database of the company performing the capital raise by identifying and comparing various characteristics of other individual company's capital raise. In an embodiment of the present disclosure, the ratings are calculated across all private equity companies raising capital. In another embodiment of the present disclosure, the ratings are calculated against private equity companies raising capital in a specific industry and a specific growth stage. In an embodiment of the present disclosure, the computing system 104 creates predetermined descriptive computer model to score or rate a private company raising equity using a database of information specific to the company and the specific of the private equity raise. It helps user to make informed decision regarding investments, and also helps companies to find out scope of improvement by comparing them with other competitor companies. The computing system 104 stores relevant information pertaining to the private equity raise in a computer-accessible database in association with other information identifying the selected private equity raises. Further, private equity raises five metrics rating for ranking against other companies either specifically in the company industry or growth stage or against all other companies raising private equity to create an overall rating. Furthermore, the computing system 104 provides quantitative rating for private crowdfunding equity capital raises. In an embodiment of the present disclosure, data is collected associated with the company raising capital, team, market, financials, traction, and competitors. Further, the one or more companies that are actively raising are compared to each other to generate a number between one (lowest score) and five (highest score).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for rating equity crowdfunding capital raises, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data receiver module configured to receive a set of equity raise metrics associated with one or more companies from an external database, wherein the one or more companies raise a set of equity raises and wherein the set of equity raise metrics comprise: one or more price parameters, one or more market parameters, one or more team parameters, one or more differentiators parameters and one or more performance parameters;
a data obtaining module configured to obtain a plurality of datapoints of the set of equity raises corresponding to the set of equity raise metrics from the external database, wherein the plurality of datapoints comprise: a set of price data points, a set market data points, a set of team data points, a set of differentiators data points and a set of performance data points;
a score calculation module configured to calculate a set of z-scores corresponding to each of the plurality of datapoints associated with each of the one or more companies by applying a standardization technique on each of the obtained plurality of datapoints;
a score generation module configured to generate a set of scores for each of the set of equity raise metrics associated with the one or more companies based on the received set of equity raise metrics, the obtained plurality of datapoints and the calculated set of z-scores by using a min-max scaler;
a rating determination module configured to determine an overall raise rating of each of the one or more companies by comparing the generated set of scores associated with the one or more companies with each other based on one or more rating parameters and a set of predefined rating rules, wherein the one or more rating parameters comprise at least one of: company industry, growth stage and all companies raising private equity; and
a data output module configured to output the generated set of scores and the determined overall raise rating on user interface screen of one or more electronic devices associated with one or more users.

2. The computing system of claim 1, further comprises a rating generation module configured to generate an overall rating for each of the set of equity raise metrics associated with the one or more companies based on the received set of equity raise metrics, the obtained plurality of datapoints and the generated set scores by computing average of the generated set scores, wherein the overall rating for each of the set of equity raise metrics comprises: price rating, market rating, team rating, differentiation rating and performance rating.

3. The computing system of claim 1, wherein in generating the set of scores for each of the set of equity raise metrics associated with the one or more companies based on the received set of equity raise metrics, the obtained plurality of datapoints and the calculated set of z-scores by using the min-max scaler, the score generation module is configured to:
generate a set of ranks for each of the set of z-scores corresponding to each of the plurality of datapoints by applying a normal distribution function on the set of z-scores, wherein the set of ranks are generated to rank the set of z-scores against each other; and
convert the set of ranks to the set of scores by using the min-max scaler, wherein the set of scores ranges from one to five.

4. The computing system of claim 1, wherein the one or more price parameters comprise: valuation cap, pre-money-valuation, discount rate, and security type.

5. The computing system of claim 1, wherein the one or more market parameters comprise: addressable market size, market growth, market growth rate, distribution model and revenue model.

6. The computing system of claim 1, wherein the one or more team parameters comprise: founder's experience, number of relevant advisors, notable inventors, founder's education, execution track record, size of network, previous exits, whether founders have worked together previously, whether founders have complementary skill sets and diversity of team.

7. The computing system of claim 1, wherein the one or more differentiators parameters comprise: number of patents, number of direct competitors, whether company's at least one of: product and service has a higher quality and lower price compared to one or more competitor companies, barriers to entry, one or more business partnerships, margin level and capital intensity.

8. The computing system of claim 1, wherein the one or more performance parameters comprises: annual revenue, monthly burn rate, growth since the last founding round, asset to liability ratio, number of users, number of paying customers and development phase.

9. The computing system of claim 1, further comprises a risk determination module configured to:
receive a set of risk metrics associated with the one or more companies from the external database;
obtain a set of risk datapoints of the set of equity raises corresponding to the set of risk metrics from the external database;
calculate a plurality of z-scores corresponding to each of the set of risk datapoints associated with each of the one or more companies by applying the standardization technique on each of the obtained set of risk datapoints;
generate a plurality of scores for each of the set of risk metrics associated with the one or more companies based on the received set of risk metrics, the obtained set of risk datapoints and the calculated plurality of z-scores by using the min-max scaler;
determine an overall risk rating of each of the one or more companies by comparing the generated plurality of scores associated with the one or more companies with each other based on the one or more rating parameters and the set of predefined rating rules; and
output the plurality of scores and the determined overall risk rating on user interface screen of the one or more electronic devices associated with the one or more users.

10. The computing system as claimed in claim 9, wherein the set of risk metrics comprise: product risk, team risk, market risk, legal risk, funding risk, investment terms risk, time risk, and financial risk.

11. A method for rating equity crowdfunding capital raises, the method comprising:
receiving, by one or more hardware processors, a set of equity raise metrics associated with one or more companies from an external database, wherein the one or more companies raise a set of equity raises and wherein the set of equity raise metrics comprise: one or more price parameters, one or more market parameters, one or more team parameters, one or more differentiators parameters and one or more performance parameters;
obtaining, by the one or more hardware processors, a plurality of datapoints of the set of equity raises corresponding to the set of equity raise metrics from the external database, wherein the plurality of datapoints comprise: a set of price data points, a set market data points, a set of team data points, a set of differentiators data points and a set of performance data points;
calculating, by the one or more hardware processors, a set of z-scores corresponding to each of the plurality of datapoints associated with each of the one or more companies by applying a standardization technique on each of the obtained plurality of datapoints;
generating, by the one or more hardware processors, a set of scores for each of the set of equity raise metrics associated with the one or more companies based on the received set of equity raise metrics, the obtained plurality of datapoints and the calculated set of z-scores by using a min-max scaler;
determining, by the one or more hardware processors, an overall raise rating of each of the one or more companies by comparing the generated set of scores associated with the one or more companies with each other based on one or more rating parameters and a set of predefined rating rules, wherein the one or more rating parameters comprise at least one of: company industry, growth stage and all companies raising private equity; and
outputting, by the one or more hardware processors, the generated set of scores and the determined overall raise rating on user interface screen of one or more electronic devices associated with one or more users.

12. The method of claim 11, further comprises generating an overall rating for each of the set of equity raise metrics associated with the one or more companies based on the received set of equity raise metrics, the obtained plurality of datapoints and the generated set scores by computing average of the generated set scores, wherein the overall rating for each of the set of equity raise metrics comprises: price rating, market rating, team rating, differentiation rating and performance rating.

13. The method of claim 11, wherein generating the set of scores for each of the set of equity raise metrics associated with the one or more companies based on the received set of equity raise metrics, the obtained plurality of datapoints and the calculated set of z-scores by using the min-max scaler comprises:
generating a set of ranks for each of the set of z-scores corresponding to each of the plurality of datapoints by applying a normal distribution function on the set of z-scores, wherein the set of ranks are generated to rank the set of z-scores against each other; and
converting the set of ranks to the set of scores by using the min-max scaler, wherein the set of scores ranges from one to five.

14. The method of claim 11, wherein the one or more price parameters comprise: valuation cap, pre-money-valuation, discount rate and security type.

15. The method of claim 11, wherein the one or more market parameters comprise: addressable market size, market growth, market growth rate, distribution model and revenue model.

16. The method of claim 11, wherein the one or more team parameters comprise: founder's experience, number of relevant advisors, notable inventors, founder's education, execution track record, size of network, previous exits, whether founders have worked together previously, whether founders have complementary skill sets and diversity of team.

17. The method of claim 1, wherein the one or more differentiators parameters comprise: number of patents, number of direct competitors, whether company's at least one of: product and service has a higher quality and lower price compared to one or more competitor companies, barriers to entry, one or more business partnerships, margin level and capital intensity.

18. The method of claim 11, wherein the one or more performance parameters comprises: annual revenue, monthly burn rate, growth since the last founding round, asset to liability ratio, number of users, number of paying customers and development phase.

19. The method of claim 11, further comprises:
receiving a set of risk metrics associated with the one or more companies from the external database;
obtaining a set of risk datapoints of the set of equity raises corresponding to the set of risk metrics from the external database;
calculating a plurality of z-scores corresponding to each of the set of risk datapoints associated with each of the one or more companies by applying the standardization technique on each of the obtained set of risk datapoints;
generating a plurality of scores for each of the set of risk metrics associated with the one or more companies based on the received set of risk metrics, the obtained set of risk datapoints and the calculated plurality of z-scores by using the min-max scaler;
determining an overall risk rating of each of the one or more companies by comparing the generated plurality of scores associated with the one or more companies with each other based on the one or more rating parameters and the set of predefined rating rules; and
outputting the plurality of scores and the determined overall risk rating on user interface screen of the one or more electronic devices associated with the one or more users.

20. The method as claimed in claim 19, wherein the set of risk metrics comprise: product risk, team risk, market risk, legal risk, funding risk, investment terms risk, time risk, and financial risk.
